(19) United States
(12) Patent Application Publication
(10) Pub. No.: US 2026/0045779 A1
(43) Pub. Date: Feb. 12, 2026

(54) Leakproof Cable Harness

(71) Applicant: HIRSCHMANN AUTOMOTIVE GMBH, Rankweil/Brederis (AT)

(72) Inventor: Roland KONZETT, Feldkirch (AT)

(21) Appl. No.: 19/100,653

(22) PCT Filed: Oct. 24, 2023
(86) PCT No.: PCT/EP2023/079679

§ 371 Date: Feb. 3, 2025

(30) Foreign Application Priority Data
Oct. 27, 2022 (DE) 102022128580.4

(51) Int. Cl. H02G 15/013; H02G 3/08; H02G 15/007

(52) U.S. Cl. CPC H02G 15/013; H02G 3/088; H02G 15/007

(57) ABSTRACT

An arrangement comprises a housing with an opening and a sheathed cable. The sheathed cable is inserted through the opening in the direction of the interior of the housing. A soft component is molded onto an end region of the sheathed cable. At least a portion of the soft component is inserted and pressed into the opening.

The invention relates to an arrangement, in particular a base piece including a cable harness, preferably an electric drive for vehicle doors for various applications, according to the features of the preamble of patent claim 1.

In a proposed design of the cable harness, the module (arrangement and cable harness) is to be assembled from a plurality of individual components and then sealed against external moisture using a potting compound. In order to assemble the module according to the assembly specifications, a plurality of process steps are necessary which are labor-intensive and complex. In addition, the potting process in this design is not considered to be reliably manufacturable because, due to the design of the individual parts, the potting compound can run into the grommet along the individual strands if there is insufficient clamping of the grommet, and the sealing function is thereby not ensured.

The object is to optimize the design of the arrangement, whereby this optimization simplifies assembly in production and also increases the seal.

This object is achieved by the features of claim 1.

According to the invention, a soft component is molded onto an end region of the sheathed cable, and at least a part of the soft component is inserted and pressed into the opening. The advantage of molding on the soft component is that the sheathed cable can be prepared in such a way that it can be easily inserted into the opening in the housing. Furthermore, the use of a material that is softer than the housing is advantageous because the soft component can settle on the inner contour of the opening in order to achieve the required sealing effect. This seal between the soft component and the housing is increased by the fact that the soft component is pressed into the opening. The advantage of molding the soft component onto the outer sheath of the sheathed cable (i.e. any cable) is that this improves the sealing effect between the outer sheath and the region of the soft component that is inserted and pressed into the opening of the housing. The material of the soft component is softer than the material of the housing. This allows the soft component to be at least slightly elastically deformable when it is inserted and pressed into the opening in the housing.

In a further development of the invention, it is provided that the soft component has a circumferential projection on the front side which conforms to the inner contour of the housing. This projection also improves the sealing effect since the side surface of the circumferential projection can conform to the inner contour of the housing around the opening. In addition, such a projection defines a defined position of the soft component after being inserted into the opening in the housing.

In a further development of the invention, it is provided that the soft component preferably has a circumferential projection in the middle conforming to the outer contour of the housing. This projection also improves the sealing effect since the side surface of this circumferential projection can conform to the outer contour of the housing around the opening. In addition, such a projection defines a defined position of the soft component after being inserted into the opening in the housing.

In a further development of the invention, it is provided that the soft component has a kink protection enclosing a part of the sheathed cable. As a result, the region of the sheathed cable that enters the housing or exits therefrom is protected from bends, kinks and the like, especially when the housing is mounted fixed in place and the sheathed cable is movable (or vice versa).

In a further development of the invention, it is provided that the soft component has at least one circumferential groove in the region in which it is inserted and pressed into the opening in the housing. The at least one groove, preferably exactly two or exactly three grooves, which are arranged one behind the other in the axial direction of the soft component, has the advantage that the soft component can on the one hand expand into the free space of the groove when the soft component is pressed into the opening in the housing. This simplifies the assembly process with an unchanged sealing effect. On the other hand, there is the advantage that the at least one groove can be filled with a material which has sliding properties in order to facilitate the insertion and pressing of the soft component into the opening, and/or which has sealing properties in order to also improve the sealing effect of the soft component in the opening in the housing with this material.

In a further development of the invention, it is provided that the soft component has at least one circumferential bead in the region in which it is inserted and pressed into the opening 5 in the housing. By means of this bead, preferably exactly two or exactly three beads, the sealing effect can be improved when the soft component is inserted and pressed into the opening in the housing. By deforming the at least one bead which is elastically deformable due to the material properties of the soft component, an additional pressure or a spring effect is generated which advantageously causes a long-lasting sealing effect.

In a further development of the invention, it is provided that the material of the soft component and the material of the outer sheath of the sheathed cable form an integral connection after the overmolding. All connections in which the connecting partners are held together by atomic or molecular forces are called integral connections. This provides a particularly good seal between the inner contour of the soft component and the outer sheath of the sheathed cable, which has a beneficial effect on the longitudinal watertightness.

As a technically producible solution, an optimized design was created according to the invention, which is intended to facilitate assembly in production and also to meet the technical requirements with regard to the seal against penetrating moisture.

For this purpose, a concept was developed in which the employed sheathed cable is overmolded with a soft component which is then to be fitted into the base piece. The soft component creates a leakproof connection between the sheathed cable and the base piece which prevents moisture from penetrating from the outside. In addition, the soft component is intended to better meet the mechanical requirements of the application with regard to tensile and compressive loads.

Due to the soft component overmolding at the end of the sheathed cable insulation, longitudinal watertightness of the individual strands is also achieved.

Overall, the new design simplifies assembly of the module and increases the robustness in terms of the seal against moisture from the environment. This is achieved specifically and especially by an arrangement according to the invention, in particular a base piece, including a cable set, preferably an electric drive for vehicle doors for various applications, wherein the employed sheathed cable is overmolded with a soft component which is then to be fitted (passed through) into a housing of the arrangement, in particular into the base piece, wherein the soft component is pressed into an opening in the housing (the base piece) to create a leakproof connection to the sheathed cable and the housing in the region of the opening (of the base piece) which prevents the penetration of moisture from the outside.

An exemplary embodiment of the invention is shown in the single figure and described below.

An arrangement 1 comprises a housing. In this case, the housing consists of a lower part 2 (also called base piece), an intermediate part 3 and an upper part 4. There may be more or fewer parts than the three shown. The housing can be used, for example, for an electric drive for vehicle doors so that in this example, an electric motor or the like, a control system that is arranged on a circuit board and, if necessary, other sensors and/or actuators are also arranged therein.

It is important for the invention that the housing, here in this exemplary embodiment the lower part 2, has an opening 5, wherein a sheathed cable 6 (i.e. generally a cable for power supply, signal transmission and the like) is to be inserted and passed through this opening 5. The sheathed cable 6 has at least one individual strand 7 (generally a sheathed electrical conductor), wherein in this exemplary embodiment, two individual strands 7 are shown. The sheathed cable 6 can also have more than two individual strands 7. The end of the individual strands 7 is contacted with corresponding contact points on a circuit board which is arranged here in the intermediate part 3.

A soft component 8 is molded onto the sheathed cable 6, in particular onto its end. In this exemplary embodiment, a kink protection 9 is molded together with the soft component 8, starting from one end. This kink protection 9 may be present, but does not have to be present.

In this exemplary embodiment, the soft component 8 has a circumferential projection 11 on the front side conforming to the inner contour of the housing and preferably a circumferential projection 10 in the middle conforming to the outer contour of the housing. These two projections, which have a larger diameter than the inner diameter of the opening 5 has, increase the sealing effect and achieve a defined position of the soft component 8 in the opening 5 of the housing when the sheathed cable 6 with its molded-on soft component 8 is inserted and pressed into the opening 5 of the housing. For assembly, it is either provided that a free end of the sheathed cable 6 is guided from the inner region of the lower part 2 through the opening 5 until the soft component 8 reaches the region of the opening 5 and is thereby inserted and pressed in. Or it is also possible, before the electrical contact of the at least one individual strand 7, for example with the circuit board in the intermediate part 3, to pass the front end of the sheathed cable 6 through the opening 5 to be inserted and pressed in there. Only then can the individual strands 7 be contacted with the circuit board, with a sensor, with an actuator or the like.

The figure shows that one end of the sheathed cable 6 which projects into the interior of the housing ends with the circumferential projection 11, and only the individual strands 7 project further into the housing. Alternatively, depending on the geometric design of the housing, this end of the sheathed cable 6 can also extend beyond the projection 11 further into the interior of the housing.

Furthermore, in this exemplary embodiment, it is shown that the soft component 8 in the region in which it is inserted and pressed into the opening 5 in the housing has at least one circumferential groove 12, here exactly three grooves 12 running one behind the other and parallel to one another in the axial direction. Alternatively or additionally, the soft component 8 can have at least one circumferential bead in the region in which it is inserted and pressed into the opening 5 in the housing. For example, it is conceivable that a plurality of grooves and beads are provided which alternate in the axial direction.

### LIST OF REFERENCE SIGNS

1. Arrangement
2. Lower part
3. Intermediate part
4. Upper part
5. Opening
6. Sheathed cable
7. Individual strands
8 Soft component
9. Kink protection
10. Circumferential projection
11. Circumferential projection
12. Circumferential groove

1. -7. (canceled)

8. An arrangement comprising a housing with an opening and a sheathed cable inserted through the opening in the direction of an interior of the housing, wherein a soft component is molded onto an end region of the sheathed cable, and at least a portion of the soft component is inserted and pressed into the opening.

9. The arrangement of claim 8, wherein the soft component has a circumferential projection on a front side of the soft component that conforms to an inner contour of the housing.

10. The arrangement of claim 8, wherein the soft component has a circumferential projection in a middle of the soft component that conforms to an outer contour of the housing.

11. The arrangement of claim 8, wherein the soft component has a kink protection enclosing a part of the sheathed cable.

12. The arrangement of claim 8, wherein the soft component has at least one circumferential groove in a region in which the soft component is inserted and pressed into the opening in the housing.

13. The arrangement of claim 8, wherein the soft component has at least one circumferential bead in a region in which the soft component is inserted and pressed into the opening in the housing.

14. The arrangement of claim 8, wherein a material of the soft component and a material of an outer sheath of the sheathed cable form an integral connection after overmolding.
